(19) United States
(12) Patent Application Publication
(10) Pub. No.: US 2015/0103389 A1
(43) Pub. Date: Apr. 16, 2015

(54) PORTABLE POWER SUPPLIES AND PORTABLE CONTROLLERS FOR SMART WINDOWS

(71) Applicants: Erich R. Klawuhn, Los Altos, CA (US); Dhairya Shrivastava, Los Altos, CA (US); Trevor Frank, San Jose, CA (US); Victor Beylin, Fremont, CA (US); Stephen C. Brown, San Mateo, CA (US); Todd Martin, Mountain View, CA (US); Robin Friedman, Mountain View, CA (US)

(72) Inventors: Erich R. Klawuhn, Los Altos, CA (US); Dhairya Shrivastava, Los Altos, CA (US); Trevor Frank, San Jose, CA (US); Victor Beylin, Fremont, CA (US); Stephen C. Brown, San Mateo, CA (US); Todd Martin, Mountain View, CA (US); Robin Friedman, Mountain View, CA (US)

(73) Assignee: VIEW, INC., Milpitas, CA (US)

(21) Appl. No.: 14/401,081

(22) PCT Filed: May 24, 2013
(86) PCT No.: PCT/US2013/042765

§ 371 Date: Nov. 13, 2014

Related U.S. Application Data
(60) Provisional application No. 61/652,021, filed on May 25, 2012.

(51) Int. Cl. G02F 1/163; E06B 9/24

(52) U.S. Cl. CPC G02F 1/163; E06B 9/24; E06B 2009/2464
USPC 359/275; 359/238

(57) ABSTRACT

A portable controller having a portable power supply for transitioning tint of an optical device such as an electrochromic device. The portable power supply has at least one battery located within a housing and a support structure for supporting the battery. The portable controller has circuitry with logic for controlling power to the optical device. In some cases, the portable power supply may provide a higher than normal drive voltage to the optical device to accelerate transition to the tint state and then may reduce the drive voltage to a normal level.

### CROSS-REFERENCE TO RELATED APPLICATION

This application claims benefit of U.S. Provisional Patent Application Ser. No. 61/652,021, filed on May 25, 2012, titled “PORTABLE POWER SUPPLIES AND PORTABLE CONTROLLERS FOR SMART WINDOWS,” which is hereby incorporated by reference in its entirety.

### FIELD

This disclosure relates to portable power supplies and portable controllers for optical devices.

### BACKGROUND

Optical devices, such as smart windows, oftentimes have an associated change in optical properties as part of their function. For example, many optical device technologies, e.g. electrochromics, suspended particle devices (SPDs), liquid crystal devices (LCDs) etc., need a small voltage be applied across transparent electrodes of a device on a transparent substrate, such as glass, in order to induce an optical change in the optical device, for example changing from a non-tinted state to a tinted state or vice versa. These functions are part of the allure of smart window technologies and may be taken for granted by the end user. However, the end user is typically seeing the final installation of the optical technology, i.e., a hard-wired version that has a dedicated power supply and associated controller.

As part of the installation process, a smart window is connected to a power source, e.g., a low voltage line that feeds power to the unit. A switch is used to turn the power on or off to the smart window. The smart window also has an associated controller. Thus, the smart window functions using the power supplied from a dedicated voltage line in combination with an associated controller. However, the optical device components of such smart windows need to be tested prior to fabrication into a final unit, e.g., an insulated glass unit (IGU) or other window assembly that is shipped to the customer.

Dedicated power lines may be cumbersome in a factory setting, where optically switchable parts are moved around, e.g. on an assembly line, during handling, and for quality control at various test stations in the factory. It may be problematic to either continue to apply, disengage, and reapply power cords to the device during movement from test station to test station in a factory, or to configure a dedicated power line that can accommodate movement of the optically switchable part through the various stations in a factory. Moreover, conventional portable power supplies are not suitable for the particular powering needs of modern optical devices.

### SUMMARY

Described are portable power supplies and portable controllers for optical devices. These are useful for any optical device, but for simplicity are described here in terms of smart windows, more specifically electrochromic (EC) windows, as certain aspects described are particularly useful when applied to features of EC windows.

One embodiment is a portable power supply for transitioning an optical device of an IGU to a tint state. The portable power supply comprises a battery power source for providing power to the optical device. The portable power supply includes at least one battery. The portable power supply also has a support structure for supporting the power source and a switch for turning on/off power to the optical device once activated by a user. In some cases, the portable power supply may have a limiting circuit for limiting power to the optical device.

One embodiment is a method of transitioning an EC device to a tint state. The method comprises using a portable power supply to provide a higher than normal drive voltage to the EC device to transition the EC device to the tint state in a first period of time. The first period of time is shorter than a normal period for transitioning to the tint state using the normal drive voltage. The method also reduces the drive voltage after the first period of time.

One embodiment is a portable controller for transitioning tint level of one or more optical devices. The portable controller has a housing, a portable power supply, and circuitry with logic for controlling power provided by the power source to the one or more optical devices. The portable power supply comprises a power source located within the housing and a support structure for supporting the power source within the housing. The power source provides power to the one or more optical devices. In some cases the portable power supply is configured to provide power at a higher than normal drive voltage to one or the one or more optical devices to transition the optical device to the state in a first period of time, wherein the first period of time is shorter than a normal period for transitioning to the tint state using the normal drive voltage, and wherein the power supply is configured to reduce the power after the first period of time.

One embodiment is portable controller for controlling transitioning EC devices to different tint states. The portable controller comprises a housing, a portable power supply, and a single timer circuit. The portable power supply comprises a power source located within the housing, the power source for providing power to the EC devices and a support structure for supporting the power source within the housing. The single timer circuit is configured to control power to transition a first EC device of the EC devices to a first tint level and transition a second EC device of the EC devices to a second tint level, the first tint level different from the second tint level. In some cases, the single timer circuit is further configured to remove the drive voltage after a certain period of time. In some cases, the portable controller further comprises one or more H-bridge circuits.

These and other features and advantages will be described in further detail below, with reference to the associated drawings.

### BRIEF DESCRIPTION OF THE DRAWINGS

The following detailed description can be more fully understood when considered in conjunction with the drawings in which:

FIG. 1 shows an example of a voltage profile for driving optical state transitions for an electrochromic device.

FIG. 2 is a cross-sectional schematic of an EC device on a glass lite with associated electrical connections.

FIG. 3 illustrates operations for fabricating an IGU including an EC lite and incorporating the IGU into a frame.

FIG. 4 shows an example of a manner in which an IGU including an EC lite may be transported during fabrication and/or testing.

FIG. 5 illustrates an IGU including an EC lite during transport and/or testing with a portable power supply as described herein.

FIG. 6 includes photographs of a portable controller as described herein.

FIG. 7 is a schematic of the circuitry of the portable controller depicted in FIG. 6.

### DETAILED DESCRIPTION

Described are portable power supplies and portable controllers for optical devices. These portable power supplies and portable controllers are useful for any optical device, but for simplicity are described in many instances herein in terms of smart windows, and more specifically in terms of EC windows, as certain aspects described are particularly useful when applied to features of EC windows. For simplicity, the terms “EC device” or simply “device” are used liberally to refer to an EC device itself, an EC device on a transparent substrate, i.e. an “EC lite,” an IGU including an EC lite, a window assembly including such an IGU, and/or any other optical device that needs electrical power to switch from one tinted state to another tinted state (e.g., clear state) or vice versa.

As used herein, the term “portable power supply” is generic to “portable controller,” because portable controllers described herein may include a power supply. Certain embodiments describe portable power supplies that may not include some of the control circuitry described in relation to some portable controller embodiments. Thus, a portable controller may be a particular type of portable power supply. A portable power supply may include at least the features of a battery power source and a support structure for the battery power source. A portable power supply may also include at least one switch for turning on, or off, the power delivered to the EC device; an electrical coupler, such as a socket, plug or the like, that makes electrical connection to a complimentary connector of the EC device; and a housing where various components of the portable power supply are contained. Further features of portable power supplies and portable controllers are described in more detail below.

### Powering Versus Driving an EC Device

An EC device in its simplest form is a device that changes tint using an electrical potential and/or current flow across two electrodes. By way of example, certain EC devices use ion intercalation/de-intercalation through various materials in the device to induce color changes. The ion movement is driven by the electrical potential applied and the current flow through the device. For example, at one electrode there is applied a positive charge and at the other electrode a negative charge; positive ions in the device are repelled from the positive electrode and attracted to the negative electrode where compensating negative charges (electrons) are available. Thus “powering” the EC device can be as simple as applying a potential across the device electrodes. In practice, EC devices are made of particular materials, use various mechanisms for coloration (including ion movement), and thus use particular voltage and/or current profiles in order to operate in a way that maximizes their performance and lifetime. Thus one may power an EC device in a number of ways, e.g. simply hooking a battery to two wires connected to bus bars of an EC device. This may color (or bleach) the device, but in a crude “brute force” way, e.g. applying far more voltage or current than necessary that may damage (or not) the device, or e.g. not optimizing performance of the device. Driving an EC device implies a particular powering scheme over time to achieve a particular result, e.g. recognizing the particular features of the EC device in question and delivering power in a particular way to achieve a particular result. An example of a drive algorithm for an EC device is described in more detail below.

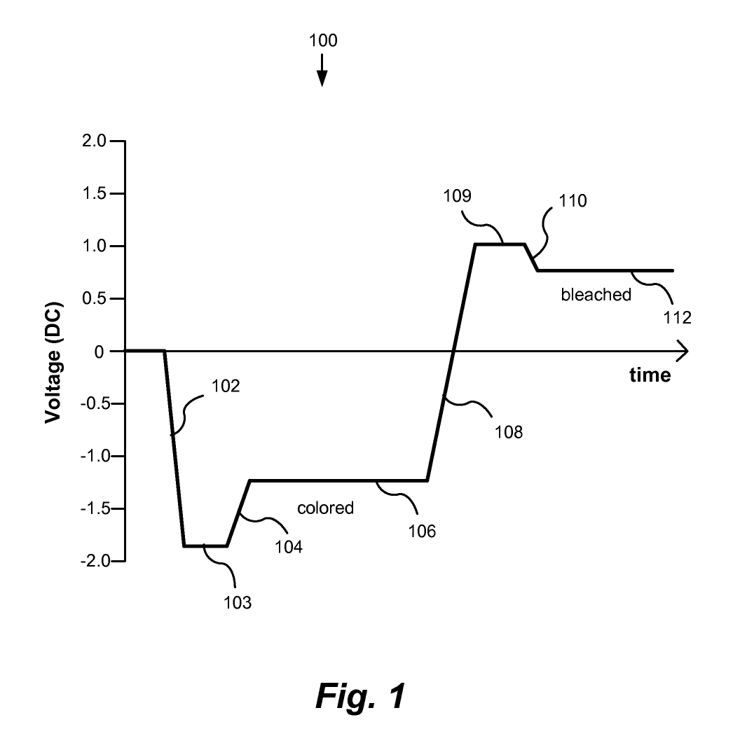

FIG. 1 shows an example of a voltage profile for driving an optical state transition for an EC device. The magnitude of the DC voltages applied to an EC device may depend in part on the thickness of the EC materials of the device and the size (e.g., area) of the device. A voltage profile, 100, includes the following sequence: a negative ramp, 102, a negative hold, 103, a positive ramp, 104, a negative hold, 106, a positive ramp, 108, a positive hold, 109, a negative ramp, 110, and a positive hold, 112. Note that the voltage remains constant during the length of time that the device remains in its defined optical state, i.e., in negative hold 106 and positive hold 112. Negative ramp 102 drives the device to the colored state and negative hold 106 maintains the device in the colored state for a desired period of time. Negative hold 103 may be for a specified duration of time or until another condition is met, such as a desired amount of charge being passed sufficient to cause the desired change in coloration, for example. Positive ramp 104, which increases the voltage from the maximum in negative voltage ramp 102, may reduce the leakage current when the colored state is held at negative hold 106.

Positive ramp 108 drives the transition of the EC device from the colored to the bleached state. Positive hold 112 maintains the device in the bleached state for a desired period of time. Positive hold 109 may be for a specified duration of time or until another condition is met, such as a desired amount of charge being passed sufficient to cause the desired change in coloration, for example. Negative ramp 110, which decreases the voltage from the maximum in positive ramp 108, may reduce leakage current when the bleached state is held at positive hold 112.

Further details regarding voltages and algorithms used for driving an optical state transition for an EC device may be found in U.S. patent application Ser. No. 13/049,623, titled “CONTROLLING TRANSITIONS IN OPTICALLY SWITCHABLE DEVICES,” filed Mar. 16, 2011, which is herein incorporated by reference. Portable controllers described herein may include capabilities to drive EC devices as described herein. Portable power supplies may not include these capabilities, but may include capabilities to power EC devices as described herein. Embodiments herein describe apparatus and methods of powering optical devices as well as driving optical devices. In order to understand power delivery to an EC device generally, described below are basic features of an EC lite and electrical connections thereto.

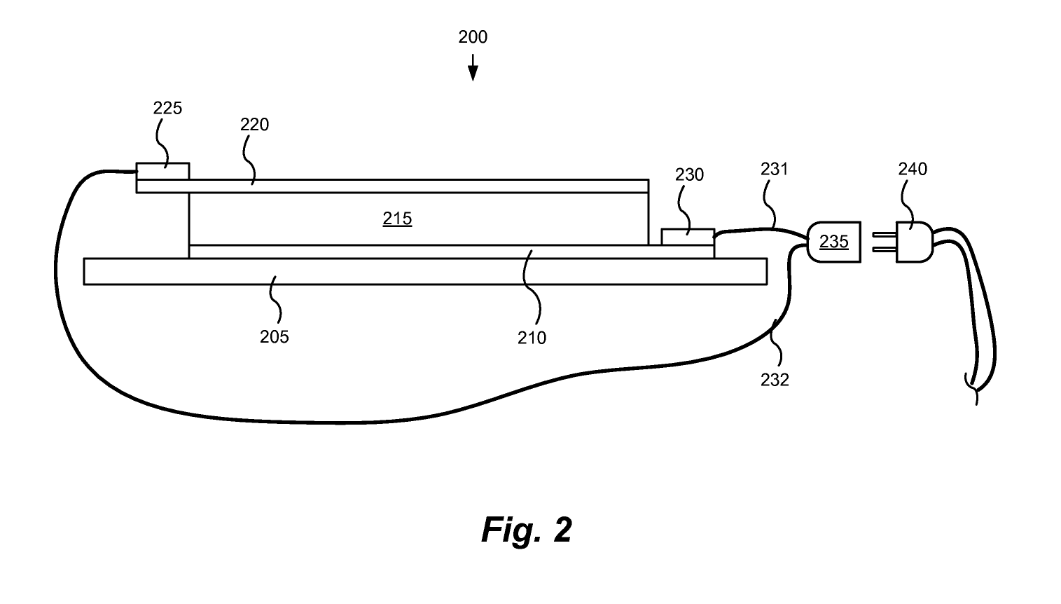

FIG. 2 shows a cross-sectional schematic of an EC lite, 200. EC lite 200 includes a substrate, 205, upon which is fabricated an EC device which includes an EC device stack, 215, sandwiched between electrode (transparent conductive oxide) layers, 210 and 220. The substrate 205 may be transparent and may be made of, for example, glass. A first transparent conducting oxide (TCO) layer, 210, is on substrate 205, with first TCO layer 210 being the first of two conductive layers used to form the electrodes of EC lite 200. EC stack 215 may include (i) an EC layer, (ii) an ion-conducting (IC) layer, and (iii) a counter electrode (CE) layer to form a stack in which the IC layer separates the EC layer and the CE layer. EC stack 215 is sandwiched between first TCO layer 210 and a second TCO layer, 220, with TCO layer 220 being the second of two conductive layers used to form the electrodes of EC lite 200. First TCO layer 210 is in contact with a first bus bar, 230, and second TCO layer 220 is in contact with a second bus bar, 225. Wires, 231 and 232, are connected to bus bars 230 and 225, respectively, and form a wire assembly (not shown) which terminates in a connector, 235. Wires of another connector, 240, may be connected to a controller (not shown) that is capable of effecting a transition of device 200, e.g., from a first optical state to a second optical state. Connectors 235 and 240 may be coupled, such that the controller may drive the optical state transition for device 200.

Further details regarding EC devices may be found in U.S. patent application Ser. No. 12/645,111, titled “FABRICATION OF LOW DEFECTIVITY ELECTROCHROMIC DEVICES,” filed Dec. 22, 2009. Further details regarding EC devices may also be found in U.S. patent application Ser. No. 12/645,159 filed Dec. 22, 2009, U.S. patent application Ser. No. 12/772,055 filed Apr. 30, 2010, U.S. patent application Ser. No. 12/814,277 filed Jun. 11, 2010, and U.S. patent application Ser. No. 12/814,279 filed Jun. 11, 2010, each titled “ELECTROCHROMIC DEVICES;” each of the aforementioned are herein incorporated by reference.

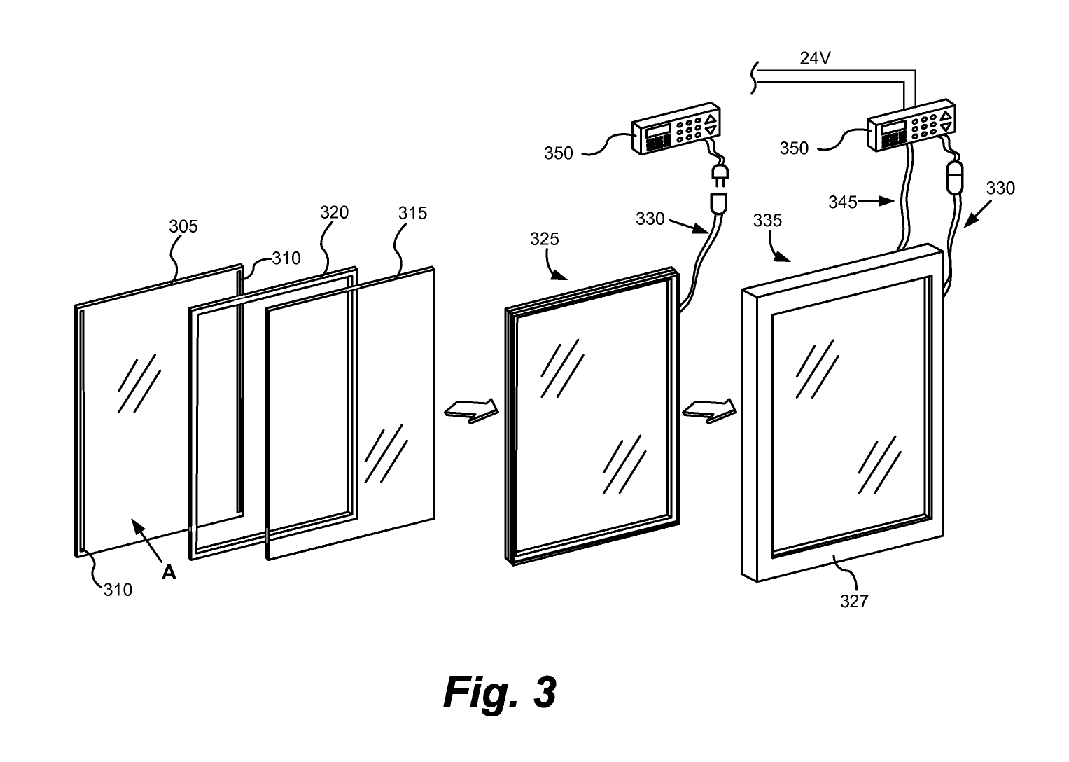

In accordance with voltage algorithms and associated wiring and connections for powering an EC device, there are also aspects of how the wired EC lite is incorporated into an IGU and how the IGU is incorporated into, e.g., a frame. FIG. 3 shows examples of the operations for fabricating an IGU, 325, including an EC lite, 305, and incorporating the IGU 325 into a frame, 327. EC lite 305 comprises a transparent substrate (e.g., glass) and an EC device (not shown, but for example may be disposed on surface A of the substrate) and bus bars, 310, which provide power to the EC device. In other cases, the EC device may be on the opposing surface of the substrate. In FIG. 3, EC lite 305 is matched with another lite, 315, which comprises a transparent substrate and may also include an EC device disposed on a surface. The EC lite 305 may include, for example, an EC device similar to the EC device shown in FIG. 2, as described above. The EC devices described herein may be, e.g., all solid state and inorganic.

During fabrication of IGU 325, a separator, 320 is sandwiched in between and registered with lites 305 and 315. IGU 325 has an associated interior space defined by the inner faces of the glass lites, 305 and 315, and the interior surfaces of the separator 320. Separator 320 may be a sealing separator, that is, the separator may include a spacer and sealing material (primary seal) between the spacer and each glass lite where the glass lites contact the separator 320. A sealing separator together with the primary seal may seal, e.g. hermetically, the interior volume enclosed by glass lites 305 and 315 and separator 320. This interior volume is thus protected from moisture. Once glass lites 305 and 315 are coupled to separator 320, a secondary seal may be applied around the perimeter edges of IGU 325 in order to impart further sealing from the ambient environment, as well as further structural rigidity to IGU 325. The secondary seal may be a silicone based sealant, for example.

IGU 325 may be wired to a window controller, 350, via a wire assembly, 330. In this example, wire assembly 330 includes wires electrically coupled to bus bars 310, that is, window controller 350 delivers power to the EC device via wire assembly 330 and busbars 310. Insulated wires in a wire assembly 320 may be braided and have an insulated cover over all of the wires, such that the multiple wires form a single cord or line. A wire assembly may also be referred to as a “pig-tail.” IGU 325 may be mounted in frame 327 to create a window assembly, 335. Window assembly 335 is connected, via wire assembly 330, to window controller, 350. Window controller 350 may also be connected to one or more sensors in frame 327 (or another element of window assembly 335) by one or more communication lines, 345. During fabrication of IGU 325, care needs to be taken, e.g., due to the fact that glass lites may be fragile, but also because wire assembly 330 extends beyond the IGU glass lites and may be damaged. Window controller 350 receives power, which it delivers to the EC device via wire assembly 330, e.g. from a low voltage power source, e.g. 24V, as depicted. Thus the right-most portion of FIG. 3 depicts a conventional powering and controller configuration for an EC device; that is, dedicated power lines, controller and EC device installed in an IGU and framing system. This is what the end user encounters.

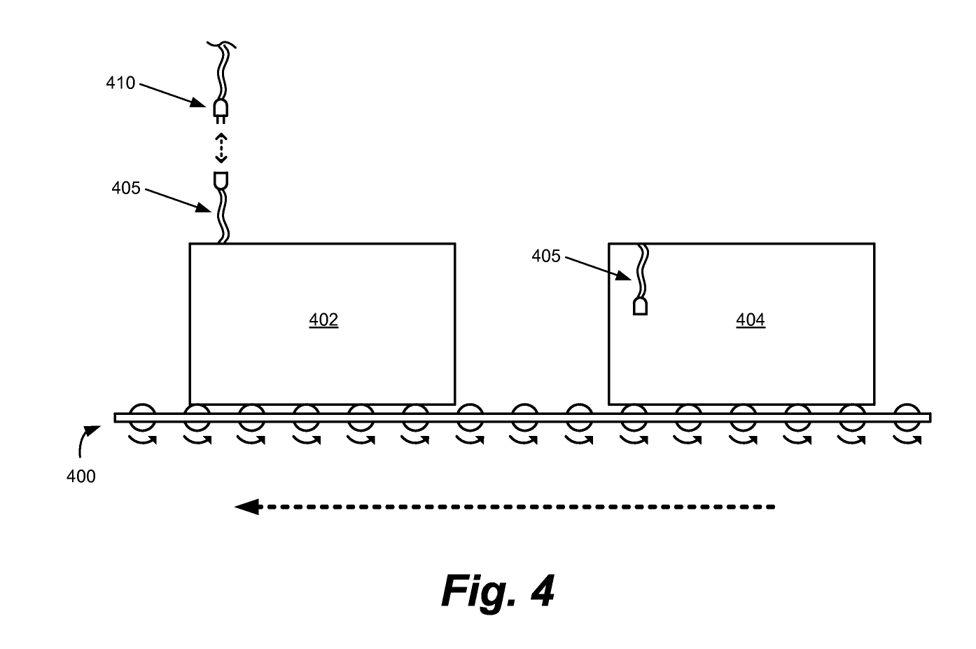

However, as described above, the EC lite and/or the IGU containing the EC lite may need to be tested in the factory. As well, there may be demonstration units in the field that need power and control functions, but without the hassle of configuring a dedicated power source or cobbling together a plug-in transformer power source with a controller that is otherwise configured for mounting with an installation. In a factory setting, dedicated power supplies for EC lites may be cumbersome and problematic, especially in an assembly line, where many EC lites are being fabricated in a high-throughput format. This is described in relation to FIG. 4.

FIG. 4 shows an example of the manner in which an IGU, including an EC lite, may be transported during the fabrication process for the IGU. As shown in FIG. 4, IGUs, 402 and 404, may be transported and handled on a transport system, 400, in a manner in which an IGU rests on its edge. For example, transport system 400 may include a number of rollers such that IGUs, 402 and 404, may easily be translated along an assembly and/or testing line. Handling an IGU in a vertical manner (e.g., with the IGU resting on its edge) has the advantage of the IGU having a smaller footprint on a manufacturing floor. Each IGU may include a wire assembly (or a pigtail), 405, with a connector that provides electrical contact to the bus bars and the EC device in each IGU. During transport on transport system 400, the wire assembly 405, although sized to avoid contact with transport system 400, oftentimes needs to be handled multiple times for testing purposes. That is, as depicted in relation to IGU 402, wire assembly 405 is connected to a power source through a connector, 410, in order to color the EC device and check for defects, test function, mitigate defects, test for coloring uniformity, etc. Once any particular test is completed on IGU 402, it is unplugged and the next IGU, 404, is connected to the power source and energized so it may be tested next. Thus testing in this manner oftentimes requires handling wire assembly 405 multiple times. This may damage the wiring within the secondary seal of the IGU due to the possibility of damage with multiple connecting and disconnecting of the wiring assembly 405. When this happens, the entire IGU may need to be replaced. Since typically the EC glazing(s) of the IGU are the most expensive feature, it is unacceptably costly to dispose of the entire IGU as a result of damaging the wiring component of the IGU assembly due to external portions of the wiring. Also, it is problematic to have multiple dedicated power supplies configured in the factory in order to perform these multiple tests. Oftentimes the IGUs are moved from one orientation, e.g. vertical as depicted, to another, e.g. horizontally, for specific tests. Some tests and fabrication steps, e.g. optical testing and/or laser scribing, may require placing the tinted EC lite or IGU in a confined area, where dedicated power lines can interfere with operation of the test equipment. Embodiments described herein avoid these issues via portable power supplies and portable EC device controllers (e.g., which may be battery powered) to allow testing and/or demonstration of optical device technology, e.g. EC devices. Typically the portable power supply or portable controller is capable of switching the state of the optical device via a manual control and the output to the optical device is limited so as not to damage the device during operation.

### Portable Power Supply and Portable Controller

A portable power supply will include at least features of a battery power source for providing power to the optical device and a support structure for supporting the battery power source. Thus, a battery alone would not be a battery power supply as described herein. Although a battery power source may include one or more batteries as a source of power, other compact and mobile power sources may also be used.

Typically, a portable power supply for an optical device will have circuitry for limiting the power provided to the optical device so as not to damage the optical device, e.g. an EC device. How power limits are set will depend on the device in question and is within the purview of one of ordinary skill in the art. In some cases, the power limits may include a maximum and/or minimum power limit. A portable power supply may also include at least one switch for turning on, or off, the power delivered to the optical device. The switch may be activated by a user (e.g., testing operator). A portable power supply may also include an electrical coupler, such as a socket, plug or the like, that makes electrical connection to a complimentary connector of the optical device. The portable power supply may also include and a housing within which one or more components of the portable power supply may be contained.

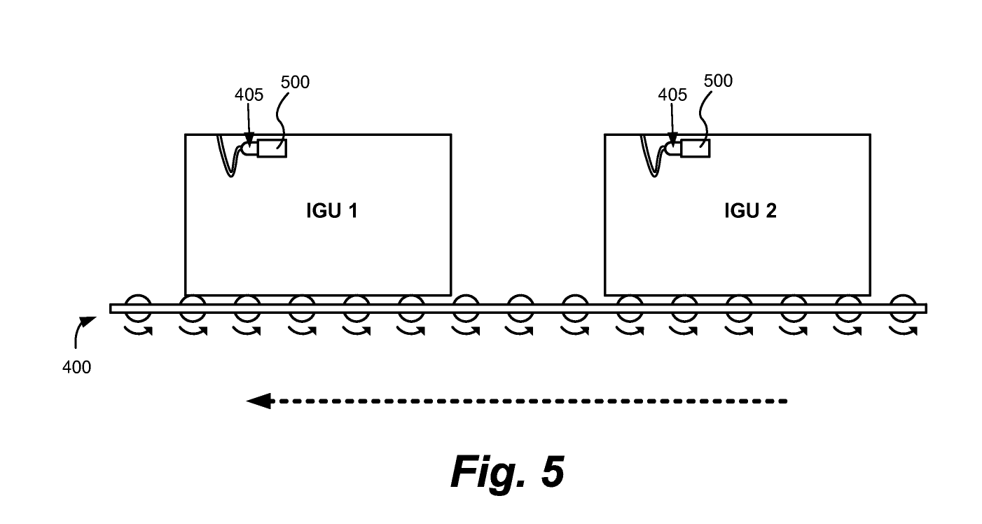

FIG. 5 illustrates a portable power supply, 500, used in conjunction with IGUs, IGU 1 and IGU 2, during transport and/or testing as described in relation to FIG. 4. Each of the IGUs, IGU 1 and IGU 2, include an EC lite. Wire assembly 405, shown as a pigtail, is plugged into portable power supply 500 at each IGU. In the illustrated embodiment, a portable power supply 500 is affixed to each IGU, e.g., via one or more attachment elements such as suction cups, sticky temporary adhesive material elements, and the like. In other embodiments, a portable power supply 500 may be hung over the edge of the IGU when in a vertical orientation or placed on the face of the IGU when in a horizontal orientation. As depicted, the portable power supply 500 obviates the need for dedicated power supplies in the fabrication facility and also the need to connect and dis-connect a dedicated power supplies as the IGUs moves along one or more fabrication and/or testing stations.

Portable power supply 500 includes one or more batteries (or other suitable power sources) for powering one or more optical devices (e.g., EC devices) in the corresponding IGU (e.g., IGU1 or IGU2). Typically, portable power supply 500 includes a switch for turning on and off the power to the optical device(s). This is particularly important as the optical device(s) may not need to be powered for various fabrication and/or testing processes in the factory. The portable power supply 500 can however travel with the IGU for whenever power is needed to transition or hold the optical device(s) at a particular optical state.

In one embodiment, a portable power supply for one or more optical devices includes: at least one battery; a power switch configured to deliver or cut-off power to the one or more optical devices; a support structure configured to support the at least one battery; a connector configured to receive an electrical connector to the one or more optical devices; and a limiting circuit configured to limit the amount of power delivered to the one or more optical devices. The limiting circuit may limit the amount of power to a predefined level that may be defined by, for example, a voltage profile. In one embodiment, the at least one battery is a rechargeable battery. In one embodiment, the portable power supply includes a housing that contains at least the at least one battery, the power switch, the support structure and the limiting circuit. In one embodiment, the portable power supply further includes at least one suction cup for attaching the portable power supply to a surface of the IGU. In one embodiment, the portable power supply further includes at least one clip for attaching the portable power supply to the IGU.

Since portable power supplies may be provide power to an optical device for short periods of time, e.g. in order to test the optical device prior to sale, they may deliver more power to the optical device than would otherwise be needed or acceptable for driving the optical device during normal operation by the end user. This over powering may be acceptable in this case because of the limited duration and nature of the powering. For example, in order to scan for optical defects, an EC lite may be placed in front of a light source and transitioned to a tinted state. Under normal driving parameters (e.g., normal drive voltage), the transition to the tinted state may take up to ten minutes. During high-volume manufacturing, this time period may be undesirable, so the optical device (e.g., EC device) may be transitioned more quickly to a tinted state using a higher than normal drive voltage. For example, a higher than normal drive voltage (e.g., 10%, 15%, 20%, etc. higher than normal) may be used to transition the optical device to the tinted state in less than one minute. The portable power supply's limiting circuit may include components configured to return the portable power supply to an acceptable voltage level (during normal operation) to hold the device in the tinted state after an initial over voltage is used to obtain the tinted state in a shorter than normal period of time. Portable controllers may include more complex circuitry. The complex circuitry may include the limiting circuit in some cases.

One embodiment is a method of transitioning an optical device (e.g., EC device) to a tinted state. The method includes providing with a portable power supply a higher than normal drive voltage to transition the optical device to the tinted state in a first period of time that is shorter than a normal period of time needed to transition to the tinted state. Then, the method reduces the drive voltage to the normal drive voltage after the first period of time. In some cases, the limiting circuit of the portable power supply may reduce the portable power supply to the normal drive voltage. In some cases, the method may maintain the drive voltage at the normal drive voltage or a drive voltage less than the normal drive voltage during a second period of time that the optical device is maintained in the tinted state. The drive voltages applied and periods of time used to transition the optical device may be defined by a voltage profile. An example of a voltage profile for driving an optical state in an EC device is shown in FIG. 1. This voltage profile describes drive voltages that can be applied during different periods of time to transition the optical device to a tinted state and to a bleached state. Other voltage profiles can be used.

Since an optical device (e.g., EC device) may use power for extended periods of time, e.g., certain optical devices may need a voltage to be applied to in order to maintain a tinted state (e.g., due to leakage current), an optical device may be transitioned to a tinted state prior to engaging with a portable power supply. For example, an IGU in a factory may be ready for a number of tests where an optical device in the IGU needs to be tinted during one or more tests. In one embodiment, the optical device is transitioned to a tinted state with a dedicated power supply at the factory and then disconnected from that dedicated power supply. Then, a portable power supply is connected and power is delivered in order to maintain the optical device in the tinted state. In this way, power from the portable power supply is used to hold the tinted state, and may not be necessarily used to transition to the tinted state. Once the portable power supply is engaged, the IGU is sent on its way through the tests. The portable power supply can then be disconnected after the IGU has completed the tests, and then the portable power supply may be returned to the area where it was first attached to the IGU for testing. In embodiments where the portable power supply has a rechargeable battery, there may be a recharge station with multiple power supplies, ready and fully charged for deployment on IGUs as they are needed. In one embodiment the recharge station includes a dedicated power source for transitioning the optical device prior to engaging the portable power supply.

In some embodiments, portable controllers may include a portable power supply such as the portable power supply described herein. Portable controllers also may include the feature of delivering power to an optical device while being recharged, and thus may serve both as a dedicated power supply at the recharge station and as a portable power supply once leaving the recharge station. Portable controllers are described in more detail below.

EC windows incorporating EC devices in a permanent installation, e.g. deployment in homes, public and commercial buildings are typically wired to a dedicated power source, because they consume sufficient power (up to 12 W each) such that a battery power source may not be a viable option over the long term. Thus, for permanent installation of EC windows, fixed locations for dedicated power sources (usually wired, but can be wireless) and window controllers may be needed. Also, permanent installations may need to hold a desired tint state for extended periods of time (e.g., hours), requiring the window controller to be continuously powered, for example, to offset the leakage current of the EC device. In addition, these permanent installations can require coordination of control of multiple EC devices and/or multiple EC windows as a group, which may require additional power consuming circuitry to facilitate communication between one or more window controllers and a network controller. However, when an EC window or other optical device is to be powered in a temporary setting, these constraints may no longer apply.

In a factory and/or testing setting, a portable power supply and/or portable controller, as described herein, may be more advantageous. In some embodiments described herein, a portable controller includes a portable power supply. In certain embodiments, a portable controller including an accelerated drive profile may be used so that optical device transitions occur in about one minute or less. These accelerated drive profiles may be desirable in certain cases, for example, when the window is being fabricated and tested, or when the window functionality is being demonstrated. Demonstrations, by nature, require holding the audience's attention, but the fact that a normal EC device transition can take on the order of ten minutes makes that difficult. For this reason, accelerated drive profiles may be desirable for demonstration purposes.

In one embodiment, a portable controller is a hand-held, battery powered, controller capable of switching the state of an optical device (e.g., EC device) and configured to control the power output to the optical device so as not to damage it during operation. The state can be switched on demand via a manual control feature in some cases. The drive profile method in the portable controller's logic may or may not be the same as would normally be used for an optical device in a permanent installation. That is, the portable controller may be configured specifically for fabrication and/or testing purposes and thus use drive algorithms that are faster than typically would be used to drive the optical device in a more permanent setting. For example, an EC window when driven with certain normal (non-accelerated) drive profiles may last for thirty years. These normal algorithms typically take into account the physical characteristics of the EC device(s) and are configured so as not to exceed certain limits that would otherwise damage the EC device if exceeded. But, for a demonstration unit, exceeding certain normal power limits or normal rates of change may be desirable if the demonstration unit is intended to last five or ten years and in order to be able to switch faster.

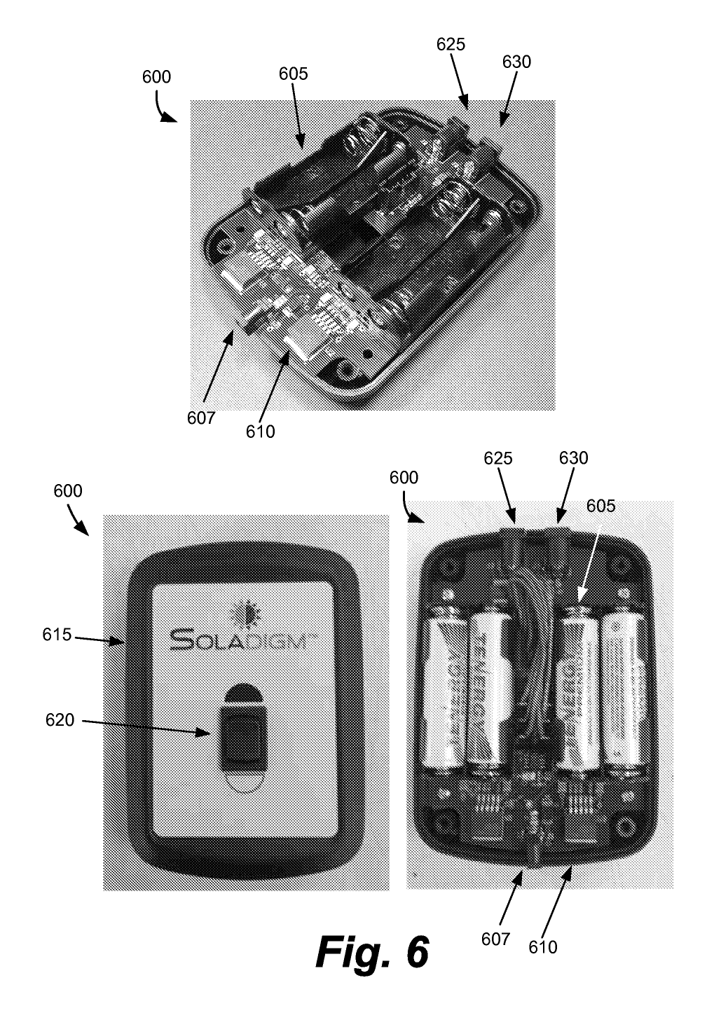

FIG. 6 includes photographs of a portable controller, 600, as described herein. Portable controller 600 is a hand-held, battery powered, optical device controller capable of switching the state of the optical device on demand via a manual operator. In this example, power is delivered to the optical device using logic based on an accelerated voltage drive profile that drives the optical device to a tint state faster than normally would occur using a normal voltage drive profile.

In one example, portable controller 600 can be used in a factory setting and may include a portable power supply such as the portable power supply described herein or other suitable portable power supply.

In many cases, the portable controller can be used for multiple IGU sizes and holds one or more batteries, which are held by supports. The one or more batteries in the portable controller can be rechargeable. The portable controller may have a housing (e.g., two-part housing) containing components of the portable controller. The portable controller also has a switch (e.g., simple rocker switch) that initiates (turns on) providing power according to the voltage power profile to the optical device and turns off (discontinues) power.

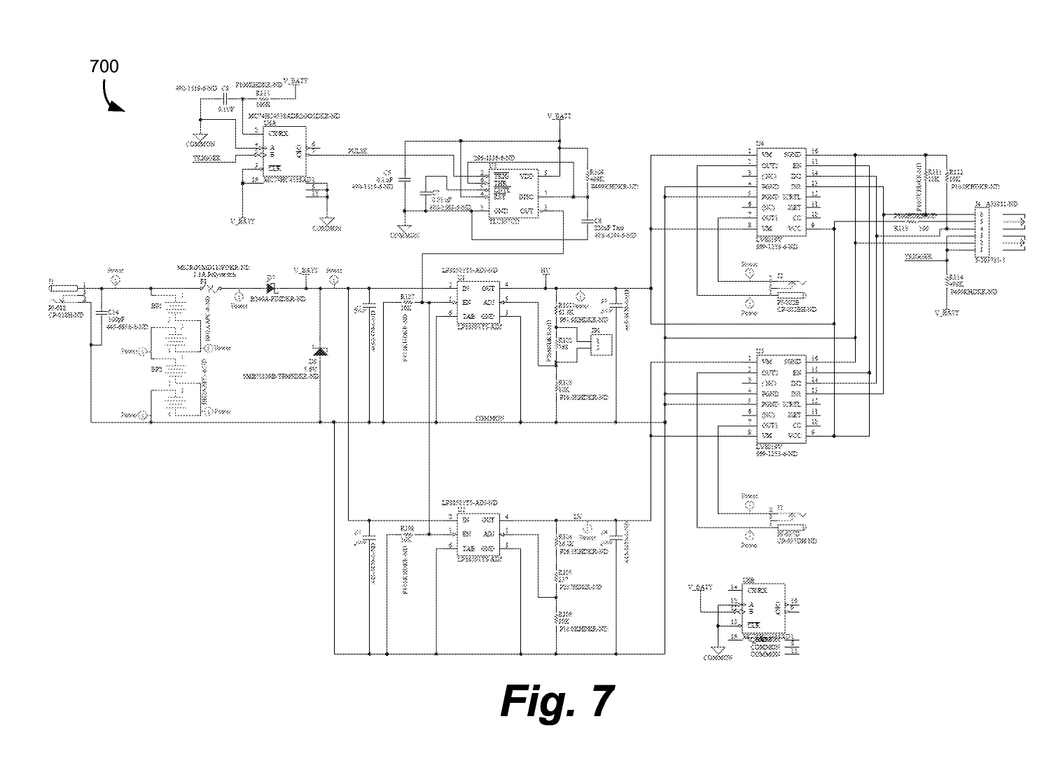

In FIG. 6, portable controller 600 is designed to be capable of being used with multiple sizes of IGUs. Portable controller 600 holds four rechargeable batteries. These batteries are held by supports 605. Portable controller 600 includes a circuit board, 610, having circuitry for the portable controller 600. The portable controller 600 also has a port, 607, that is configured to allow portable controller 600 to be connected to a battery recharger or a recharge station. In other examples, the portable controller 600 may not have this port 607. Portable controller 600 may be configured with the capability to transition an optical device during recharging. A cover, 615, is one part of a two-part housing that contains the components of portable controller 600. In this case, the two parts of the housing are connected at the four corners of the portable controller 6000. A switch, 620, can be activated to initiate (turn on) power according to a voltage power profile to the optical device to transition the optical device to a tint state, and can be activated to turn off power to the optical device. In the illustrated example, switch 620 is a simple rocker switch, with indicators for tinted and non-tinted states. In this example, the portable controller 600 can control one window or two windows (e.g., EC windows) of the same or differing sizes. The portable controller 600 includes two outputs, 625 and 630, each configured to accept a wire assembly connected to one or more optical devices in the window(s). In some cases, outputs 625 and 630 may be configured to each accept a coaxial wire assembly, with each coaxial wire assembly being part of an optical device. FIG. 7 shows an example of circuitry for portable controller 600. Further details regarding circuitry elements can be found in U.S. patent application Ser. No. 13/449,248, titled “CONTROLLER FOR OPTICALLY-SWITCHABLE WINDOWS,” filed on Apr. 17, 2012 and U.S. patent application Ser. No. 13/449,251, titled “CONTROLLER FOR OPTICALLY-SWITCHABLE WINDOWS,” filed on Apr. 17, 2012, which are hereby incorporated by reference in their entirety.

In FIG. 6, the overall dimensions of portable controller 600 are approximately 4.5″ L×3.25″ W×1.25″ H. In this particular example, controller 600 uses four AA NiMH rechargeable batteries as a balance of weight and size against number desired tint and clear cycles. Other batteries could be used, including AAA or a single 3.7V LiPO (polymer) flat pack battery. A portable controller may be smaller, for example, in one embodiment a flat pack lithium battery is used to configure the controller to about 2″×2″×⅜″ or less, and include the feature of driving two different sized windows. In another embodiment, the portable controller drives one window, and has dimensions of about 2″×1″×0.25″ or less.

Portable controller 600 utilizes battery power to make it portable. Portable controller 600 can also incorporate various power saving and optical device protection features, which may maximize the operation time of a battery charge and may provide extended periods (e.g., years) of reliable operation. For example, demonstrating EC technology is typically done with small EC devices using low enough power levels to allow for a portable operation. These demonstrations are usually done in a matter of minutes (certain EC device testing and/or fabrication are also done over short time frames), further reducing power demands, and the nature of some EC coatings is they that will continue to hold their state for some time unpowered (determined by leakage current); this behavior may be exploited in certain embodiments to further extend battery life.

In one embodiment, the battery is rechargeable. In one embodiment, the portable controller powering functionality can be maintained by drawing power from the battery charger while the batteries are being charged. In certain embodiments, voltage and time controls (e.g., those determined by a voltage profile used by the controller logic) are configured to maximize the battery life and/or protect the optical devices.

Portable controller 600 also includes a single timer circuit and two independent voltage regulators (to address different sizes of EC devices), and H-bridge circuits to switch the output polarity to the optical device to drive tinting or bleaching. The timer also protects the optical device from damage by removing the drive voltage if the user forgets to turn off the power manually. The use of voltage regulators allows for a battery charger to be simultaneously charging the batteries while powering the optical device. Having two independent voltage regulator circuits and H-bridges also allows for two different optical devices to be controlled at the same time. In one embodiment, the circuit is configured to tint one window while clearing another window.

In embodiments, portable controller provides power to transition the optical device according to a voltage profile in the drive logic of the portable controller. In one embodiment, the voltage profile for transitioning an optical device is essentially a step function, positive or negative, gated by the user moving a switch (e.g., 620) to the tint or clear position. In other embodiments, voltage ramps may be incorporated into the drive algorithm.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

Although the foregoing embodiments have been described in some detail to facilitate understanding, the described embodiments are to be considered illustrative and not limiting. It will be apparent to one of ordinary skill in the art that certain changes and modifications can be practiced within the scope of the description.

What is claimed is:

1. A portable power supply for transitioning an optical device of an IGU to a tint state, the portable power supply comprising:
a battery power source for providing power to the optical device, and including at least one battery;
a support structure for supporting the power source; and
a switch for turning on/off power to the optical device once activated by a user.

2. The portable power supply of claim 1, further comprising a limiting circuit for limiting power to the optical device.

3. The portable power supply of claim 1, wherein the optical device is an electrochromic device.

4. The portable power supply of claim 1, further comprising a housing containing one or more components of the portable power supply.

5. The portable power supply of claim 1, further comprising at least one attachment component for attaching the portable power supply to a surface of the IGU.

6. The portable power supply of claim 5, wherein the at least one attachment component comprises a suction cup.

7. The portable power supply of claim 5, wherein the at least one attachment component comprises a clip.

8. A method of transitioning an EC device to a tint state, the method comprising:
using a portable power supply to provide a higher than normal drive voltage to the EC device to transition the EC device to the tint state in a first period of time, wherein the first period of time is shorter than a normal period for transitioning to the tint state using the normal drive voltage; and
reducing the drive voltage after the first period of time.

9. The method of claim 8, wherein reducing the drive voltage after the first period of time comprises reducing the drive voltage to the normal drive voltage.

10. The method of claim 8, wherein reducing the drive voltage after the first period of time comprises reducing the drive voltage to less than the normal drive voltage.

11. The method of claim 8, wherein the drive voltage is reduced by a limiting circuit.

12. A portable controller for transitioning tint level of one or more optical devices, the portable controller comprising:
a housing;
a portable power supply comprising
a power source located within the housing, the power source for providing power to the one or more optical devices, and
a support structure for supporting the power source within the housing; and
circuitry with logic for controlling power provided by the power source to the one or more optical devices.

13. The portable controller of claim 12, further comprising a switch configured to turn on/off power to the one or more optical devices once activated by a user.

14. The portable controller of claim 12, further comprising a limiting circuit for limiting power to the one or more optical devices to a pre-defined level.

15. The portable controller of claim 12, wherein the power source includes at least one battery.

16. The portable controller of claim 12, further comprising at least one attachment component for attaching the portable controller to a surface of an IGU having at least one of the one or more optical devices.

17. The portable controller of claim 12, further comprising a plurality of independent voltage regulators to provide voltage at different levels associated with different sizes of optical devices.

18. The portable controller of claim 12, wherein the power supply is configured to provide power at a higher than normal drive voltage to one or the one or more optical devices to transition the optical device to the state in a first period of time, wherein the first period of time is shorter than a normal period for transitioning to the tint state using the normal drive voltage, and wherein the power supply is configured to reduce the power after the first period of time.

19. A portable controller for controlling transitioning EC devices to different tint states, the controller comprising:
a housing;
a portable power supply comprising
a power source located within the housing, the power source for providing power to the EC devices, and
a support structure for supporting the power source within the housing; and
a single timer circuit configured to control power to transition a first EC device of the EC devices to a first tint level and transition a second EC device of the EC devices to a second tint level, the first tint level different from the second tint level.

20. The portable controller of claim 19, wherein the single timer circuit is further configured to remove the drive voltage after a certain period of time.

21. The portable controller of claim 19, further comprising one or more H-bridge circuits.

22. The portable controller of claim 19,
wherein the power source is one or more rechargeable batteries; and
further comprising one or more voltage regulators configured to simultaneously control charging of the rechargeable batteries while powering at least one of the EC devices.
